(19) United States
(12) Patent Application Publication
(10) Pub. No.: US 2006/0149528 A1
(43) Pub. Date: Jul. 6, 2006

(54) System and method of automatic Japanese kanji labeling

(75) Inventors: Zechary Chang, Taipei (TW); Pinky Ma, Beijing (CN); Sam Sha, Beijing (CN)

Correspondence Address: Welsh & Katz, Ltd.;Eric D. Cohen, 22nd Floor, 120 South Riverside Plaza, Chicago, IL, 60606, US

(73) Assignee: Inventec Corporation, Taipei (TW)

(21) Appl. No.: 11/029,834

(22) Filed: Jan. 5, 2005

(51) Int. Cl. G06F 17/20; G06F 17/28; G06F 17/24; G06K 9/18

(52) U.S. Cl. 704/8; 715/512; 715/531; 382/185; 704/2

(57) ABSTRACT

A system of automatically labeling kanji and the method thereof are disclosed. The disclosed system includes a look-up table storing kanji and the corresponding kana, a word extraction module to extract the kanji on the current web page, a conversion module to convert the kanji into the corresponding kana, and a display module to display the kana at the position corresponding to the kanji. Therefore, the system and method can automatically label the kana according to the usual reading convention.

### BACKGROUND OF THE INVENTION

1. Field of Invention

The invention relates to a system of labeling kanji and the method thereof. In particular, it relates to a system that automatically labels kanji and the corresponding labeling method.

2. Related Art

Oral communication is an important aspect in foreign language learning. This is because the primary function of a language is communication and oral communication is the most common one. Therefore, mastering the pronunciation is very crucial when learning a new language. This is particularly true for Japanese.

Japanese is a rather complicated language in the world. It includes hiragana's, katakana, kanji, English, and Arabic numbers. Japanese uses a lot of kanji, and a difficult thing in learning Japanese is how to pronounce the kanji. The pronunciation of the kanji is usually labeled by kana. Kana is also called the syllabus symbols of Japanese. It includes two fonts; one is called the hiragana and the other is called the katakana. The hiragana is used in writing and printing. The katakana is used for foreign words and some special terms. In addition, the kana can be spelled using Roman words, called the Roman spelling.

The usual convention in Japanese is to label the kana on top of the kanji. Currently, kanji on many Japanes web pages are not labeled how to read. This is very inconvenient for beginning learners of Japanese. The user has to look up the corresponding kana in order to know the pronunciations. Some Japanese web pages do provide kana for the kanji therein. However, these are made when deisnging the web pages; a region has been reserved for the kana labels. For the web pages that are already finished, it is impossible to put labels on top of the kanji. They have to be re-edited, if necessary. Moreover, such requests are not necessary for all users. Some users do not need to know the pronunciation of the kanji. In this case, it is not necessary to label the kanji using kana and web page space can be saved. In this case, one has to design two kinds of web pages. This inevitably increases the web page editing time and resources.

It is thus important to find a way to automatically label kana on kanji according to the user's request.

### SUMMARY OF THE INVENTION

In view of the foregoing, the invention provides a system that automatically labels kana for kanji and the corresponding labeling method. An objective of the invention is to automatically label the kanji according to the user's request. Therefore, users who care about the pronunciation can immediately know how to read kanji.

To achieve the above objective, the invention provides a system for automatically labeling kana on kanji. The system includes a look-up table storing kanji and the corresponding kana, a word extraction module to extract the kanji on the current page, a conversion module to convert the kanji into the corresponding kana, and a display module to display the kana at the position corresponding to the kanji.

The invention further provides a method for automatically labeling kana on kanji. First, a look-up table is established for kanji and the corresponding kana. Afterwards, a kanji word in the current web page is extracted. The kanji is then converted into the corresponding kana according to the look-up table. Finally, the kana is displayed at a position corresponding to the kanji.

According to the disclosed system and method, all the kanji words in a Japanese web page can be labeled with kana, providing an ideal learning platform for the beginning learner. Combining with the screen word extraction function, the user can extract any kanji from the displayed web page and ask to display its kana. Therefore, the user can know of the pronunciation of the kanji immediately.

### BRIEF DESCRIPTION OF THE DRAWINGS

The invention will become more fully understood from the detailed description given hereinbelow illustration only, and thus are not limitative of the present invention, and wherein:

FIG. 1 shows a module structure of the disclosed system for automatic kana labeling;

FIG. 2 shows a module structure of the disclosed embodiment;

FIG. 3 is a flowchart of the disclosed method for automatic kana labeling;

FIG. 4 is a flowchart of the first embodiment for a whole web page conversion; and

FIG. 5 is a flowchart of the second embodiment for a mouse-selected conversion.

### DETAILED DESCRIPTION OF THE INVENTION

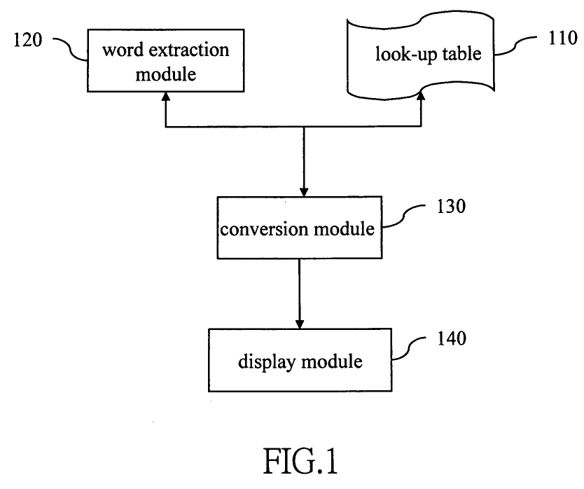

The system structure of the disclosed system is shown in FIG. 1. It includes a look-up table 110, a word extraction module 120, a conversion module 130, and a display module 140. We describe these modules in detail as follows.

(1) The look-up table 110 stores all kanji words and the corresponding kana. These include individual kanji words and the corresponding kana and kanji phrases and the corresponding kana.

(2) The word extraction module 120 extracts a kanji from the current web page according to the user's request. If the user selects to extract all kanji words in the page, the word extraction module 120 extracts all of them. If the user selects to use the mouse to pick the words, then the word extraction module 120 only extracts those clicked ones. It further determines whether the current kanji and its adjacent ones can form a phrase. If possible, it extracts the whole phrase.

(3) The conversion module 130 is connected to the word extraction module 120 to receive the contents extracted by the word extraction module 120 and to convert the kanji words into the corresponding kana according to the look-up table.

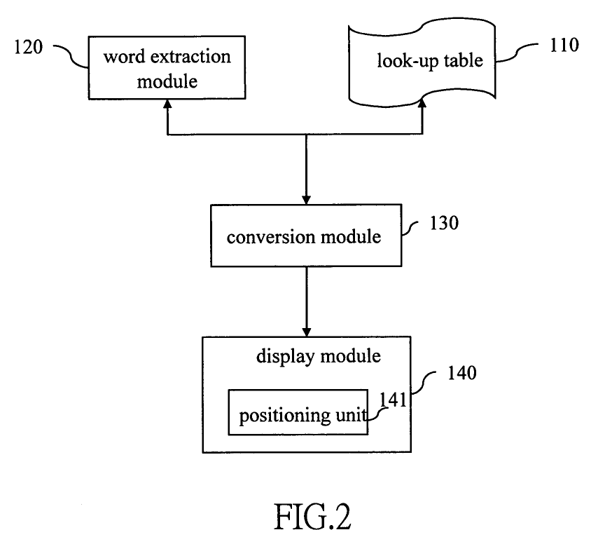

(4) The display module 140 displays a kana at an appropriate position of the corresponding kanji. The display module 140 also includes a positioning unit 141 (see FIG. 2) to decide the position where the kana should be displayed. If the user selects all kanji words in a web page, the positioning unit 141 uses the top of each kanji as the display region and uses the width of the kana as s standard to adjust the width of the kanji. It further determines when to change lines according to the currently defined line length. That is, when the text length reaches the currently defined line length, it automatically changes lines. If the user selects the mouse extraction, the positioning unit 141 automatically opens a display window at the position clicked by the mouse as the display region of the kana. Therefore, the kana is displayed at the same time when the user uses the mouse to make selections.

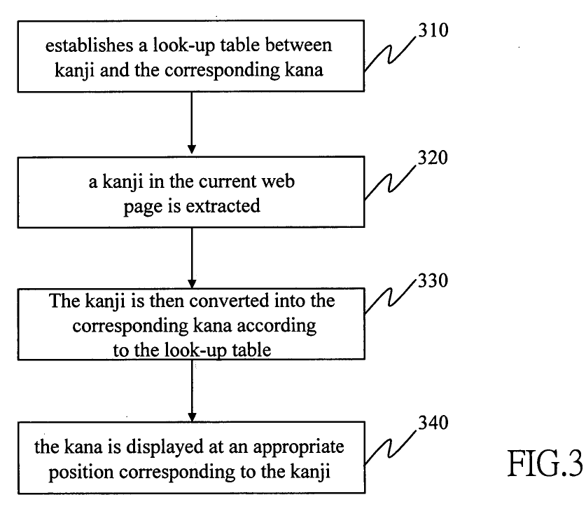

As shown in FIG. 3, the disclosed method first establishes a look-up table between kanji and the corresponding kana (step 310). Afterwards, a kanji in the current web page is extracted (step 320). The kanji is then converted into the corresponding kana according to the look-up table (step 330). Finally, the kana is displayed at an appropriate position corresponding to the kanji (step 340).

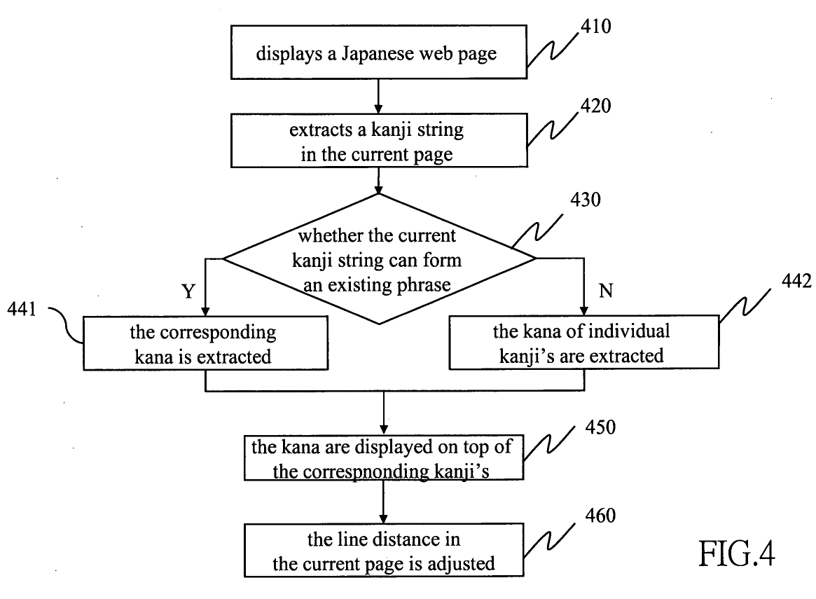

In the following, we use an example to further explain the invention. FIG. 4 is the flow chart of a first embodiment of the invention. The look-up table of the invention is established in advanced. An explicit table is shown in Table 1

TABLE 1

| Japanese Kanji | Kana |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| . . . | . . . |

The Japanese field in Table 1 includes both phrases and individual words. The phrases have higher priority than words. The extracted kanji is first compared with the phrases in the Japanese field. If there is a match, the corresponding kana is extracted. Otherwise, it further compares with the words in the look-up table.

This embodiment first displays a Japanese web page (step 410). If the user clicks the button of labeling kana, the system extracts a kanji string in the current page (step 420). During the extraction, it immediately determines whether the current kanji string can form an existing phrase (step 430). That is, the current kanji string is compared with the phrases in the look-up table. If there is a match, the string is considered as a phrase and the corresponding kana is extracted (step 441). If the current kanji and its adjacent kanji's cannot form a phrase (that is, no such phrases exist in the look-up table), then the kana of individual kanji's are extracted (step 442). For example, the sentence [symbol] [symbol] means “This is a cute bear.” After matching with the look-up table, it is converted into [symbol] [symbol] [symbol] Afterwards, the kana are displayed on top of the correspnonding kanji's (step 450). Finally, the line distance in the current page is adjusted so that each kanji is associated with a corresponding kana and the web page changes lines according to the settings (step 460). In this way, all the kanji's can be labeled with the corresponding kana.

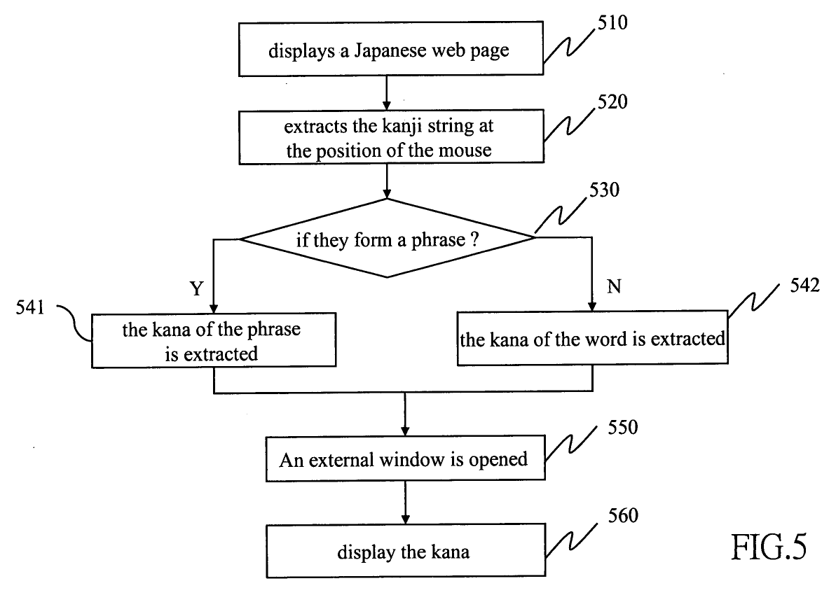

In the following, we give an example of selecting phrases or words using a mouse. FIG. 5 shows the flow chart of a second embodimnet.

This embodiment first displays a Japanese web page (step 510). If the user wants to look up the kana of a kanji in the current web page, he or she only needs to move the mouse to the kanji and click it. The system extracts the kanji string at the position of the mouse (step 520). The current kanji string is compared with the phrases in the look-up table to see if they form a phrase (step 530). If there is a match, then the kana of the phrase is extracted (step 541). If there is no match, then the kana of the word is extracted (step 542). An external window is opened at the position of the mouse (step 550) to display the kana (step 560). Therefore, the user can know of the pronunciation of a kanji at any time.

Certain variations would be apparent to those skilled in the art, which variations are considered within the spirit and scope of the claimed invention.

What is claimed is:

1. A system for automatically labeling a kanji, comprising:
a look-up table, which stores kanji's and the corresponding kana;
a word extraction module, which extracts a kanji from a current web page;
a conversion module, which converts the kanji into the corresponding kana according to the look-up table; and
a display module, which displays the kana at a position corresponding to the kanji.

2. The system of claim 1, wherein the word extraction module extracts all the kanji words in the current web page.

3. The system of claim 1, wherein the word extraction module extracts the kanji selected by the mouse.

4. The system of claim 1, wherein the display module contains a positioning unit to determine the display region of the kana.

5. The system of claim 4, wherein the display region is on top of each kanji.

6. The system of claim 4, wherein the display region is a window opened at the position of the mouse.

7. A method of automatically labeling a kanji, comprising the steps of:
establishing a look-up table between kanji's and the corresponding kana;
extracting a kanji from a current web page;
converting the kanji into the corresponding kana according to the look-up table; and
displaying the kana at a position corresponding to the kanji.

8. The method of claim 7, wherein the step of extracting a kanji from a current web page extracts all the kanji strings in the web page.

9. The method of claim 7, wherein the step of extracting a kanji from a current web page extracts a kanji clicked by the mouse.

10. The method of claim 7 further comprising the step of deciding the display region of the kana.

11. The method of claim 10, wherein the step of deciding the display region of the kana uses the top of the kanji as the display region.

12. The method of claim 10, wherein the step of deciding the display region of the kana uses a window opened at the position of the mouse as the display region.

13. The method of claim 7 further comprising the step of changing lines according to the text length.

14. The method of claim 7, wherein the step of converting the kanji into the corresponding kana according to the look-up table further includes the step of determining whether the kanji string forms a phrase.
